(19) United States
(12) Patent Application Publication
(10) Pub. No.: US 2021/0047539 A1
(43) Pub. Date: Feb. 18, 2021

(54) COATING COMPOSITION AND METHOD FOR FORMING COATING FILM

(71) Applicant: NIPPON PAINT AUTOMOTIVE COATINGS CO., LTD., Osaka (JP)

(72) Inventors: Takunori MATSUFUJI, Hirakata-shi, Osaka (JP); Karl JOOST, Hirakata-shi, Osaka (JP); Katsumi MIZUGUCHI, Hirakata-shi, Osaka (JP); Shinichi HORII, Hirakata-shi, Osaka (JP); Takashi KAWAI, Hirakata-shi, Osaka (JP)

(73) Assignee: NIPPON PAINT AUTOMOTIVE COATINGS CO., LTD., Osaka (JP)

(21) Appl. No.: 16/965,765

(22) PCT Filed: Dec. 11, 2018
(86) PCT No.: PCT/JP2018/045469

§ 371 Date: Jul. 29, 2020

(30) Foreign Application Priority Data
Jan. 31, 2018 (JP) 2018-015380

(51) Int. Cl. C09D 175/06; C08G 18/12; C08G 18/16; C08G 18/62; C08G 18/42; C08G 18/71; C08G 18/77

(52) U.S. Cl. CPC C09D 175/06; C08G 18/12; C08G 18/16; C08G 2150/00; C08G 18/42; C08G 18/718; C08G 18/778; C08G 18/6225

(57) ABSTRACT

It is an object of the present invention to provide a coating composition that is capable of forming a coating film having good coating film appearance (e.g., smoothness) and design properties and having well-balanced coating film properties such as scratch resistance, and that allows its coating film to be cured by a simple method because of being thermally curable. A further object of the present invention is to provide a method for forming a coating film, which comprises forming a coating film using the coating composition of the present invention. More specifically, the present invention provides a coating composition containing at least one branched polymer selected from a dendrimer and a hyperbranched polymer, and an isocyanate compound having an isocyanate group and an alkylsilanol group, and having the number of isocyanate functional group of 1 or more.

### TECHNICAL FIELD

The present invention relates to a coating composition. The present invention also relates to a method for forming a coating film.

### BACKGROUND ART

Coating films having various functions are formed on the surface of an article to be coated such as the exterior and interior of a vehicle body. For example, the coating film provided as the outermost layer of the article to be coated is required to have good appearance (e.g., smoothness) and scratch resistance.

Patent Literature 1 discloses a clear coating composition comprising an ultraviolet curable compound having an unsaturated bond, a photopolymerization initiator, and an acrylic copolymer, and a coating film superior in appearance and also in scratch resistance can be obtained.

Patent Literature 2 discloses an active energy ray-curable composition comprising:

(A) an ultraviolet-absorbing polymer that is obtained by copolymerizing an unsaturated monomer (a-1) having an ultraviolet absorbing group composed of a benzotriazole skeleton or a triazine skeleton and an unsaturated monomer (a-2) copolymerizable with (a-1) in a prescribed ratio and is a (meth)acrylic copolymer having a number-average molecular weight of 10,000 to 500,000;

(B) one or more ultraviolet-curable oligomers selected from a polyfunctional acrylate, a polyfunctional urethane acrylate and a polyfunctional epoxy acrylate, each having 3 or more (meth)acryloyl groups in one molecule; and

(C) a photopolymerization initiator.

### CITATIONS LIST

### Patent Literature

Patent Literature 1: JP 2004-244426 A

Patent Literature 2: JP 2013-204001 A

### SUMMARY OF INVENTION

### Technical Problems

As described in Patent Literatures 1 and 2, it is common to form a coating film by ultraviolet curing in order to achieve superior coating film appearance and superior scratch resistance. Equipment for ultraviolet curing is required to form a coating film. However, equipment for performing ultraviolet curing requires special and complicated devices, and thus the cost of coating equipment tends to increase.

On the other hand, as a coating composition capable of forming a coating film (coating film curing) more commonly than ultraviolet curable coating compositions, a thermally curable coating composition can be mentioned. In the case of a coating film formed from a commonly used thermally curable coating composition, the coating film properties, such as scratch resistance, of the coating film tend to be weaker than the scratch resistance of a coating film formed from the ultraviolet curable coating composition.

Furthermore, when a coating film is scratched on its surface, the coating film appearance is adversely affected. Thus, for example as described in Japanese Patent No. 4673938, a coating composition has been developed which has a characteristic of recovering scratches even if it is scratched. Such a coating composition can also have superior appearance. In recent years, there has been a demand for a coating composition capable of forming a coating film having superior scratch resistance and originally being less prone to be scratched.

Therefore, there is a demand for a coating composition that is capable of forming a coating film more simply at a lower cost than by ultraviolet curing without using a special device that can be used for curing an ultraviolet curable resin composition, and also capable of forming a coating film having superior scratch resistance.

In view of the above-mentioned current situation, it is an object of the present invention to provide a coating composition capable of forming a coating film having good coating film appearance (for example, smoothness) and design properties (color reproducibility, high glossiness, etc.) and well-balanced coating film properties such as scratch resistance and capable of forming a coating film by a simple method.

A further object of the present invention is to provide a method for forming a coating film, which comprises forming a coating film using the coating composition of the present invention.

### Solutions to Problems

In order to solve the above-described problems, the present invention provides the following embodiments.

[1] A coating composition comprising:

at least one branched polymer selected from a dendrimer and a hyperbranched polymer; and

an isocyanate compound having an isocyanate group and an alkylsilanol group, and having the number of isocyanate functional group of 1 or more.

According to this embodiment, it is possible to form a coating film having good appearance (for example, smoothness) and design properties of the coating film and having well-balanced coating film properties including scratch resistance.

[2] The coating composition according to [1], wherein the branched polymer is a hyperbranched polyester.

According to this embodiment, a polyester polymer having a multibranched structure can be bonded to an isocyanate compound, and it is possible to obtain a coating film having the flexibility of the polyester polymer with a multibranched structure and also having an improved scratch resistance resulting from the self-condensation of alkylsilanol groups of the isocyanate compound and good coating film hardness.

[3] The coating composition according to [1] or [2], wherein the hydroxyl value of the branched polymer is 170 mg KOH/g or more and 300 mg KOH/g or less.

According to this embodiment, a coating film having a higher crosslinking density can be formed, and further improved scratch resistance and better coating film hardness can be achieved.

[4] The coating composition according to any one of [1] to [3].

wherein the isocyanate compound has one or more alkylsilanol groups represented by formula (1),

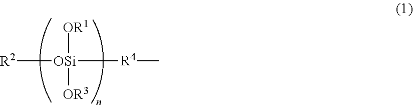

wherein R¹, R² and R³ are hydrocarbon groups having 1 to 20 carbon atoms and optionally having a substituent, provided that R¹, R² and R³ may be either the same as or different from each other,

R⁴ is a hydrocarbon group having 1 to 20 carbon atoms and optionally having a substituent, and

n is 1-10.

According to this embodiment, scratch resistance due to self-condensation of alkylsilanol groups can be further improved, and a coating film having better coating film hardness can be obtained.

[5] The coating composition further comprises a metal-free organic ion catalyst.

According to this embodiment, the crosslinking reaction between the branched polymer and the isocyanate compound is promoted, and the coating film can be formed at a lower temperature. Moreover, the curing time of the coating composition can be further shortened.

According to another embodiment of the present invention, the following method for forming a coating film is provided.

[6] A method for forming a coating film, comprising:

applying the coating composition mentioned above to an article to be coated; and

heating the coating composition to form a cured coating film,

wherein the coating composition comprises a catalyst, and

the heating is performed when the article to be coated is within a temperature of 70° C. or higher and 90° C. or lower.

According to this embodiment, the reaction between the branched polymer and the isocyanate compound is promoted, and the coating film can be formed at a lower temperature. Moreover, the curing time of the coating composition can be further shortened.

[7] The method according to [6], wherein the catalyst is a metal-free organic ion catalyst.

### Advantageous Effects of Invention

The coating composition of the present invention can form a coating film having good coating film appearance (for example, smoothness) and design properties, and having well-balanced coating film properties such as scratch resistance.

### DESCRIPTION OF EMBODIMENTS

(Coating Composition)

The coating composition of the present invention having such technical effects is a coating composition comprising at least one branched polymer selected from a dendrimer and a hyperbranched polymer, and

an isocyanate compound having an isocyanate group and an alkylsilanol group, and having the number of isocyanate functional group of 1 or more.

The coating composition of the present invention can form a coating film having good coating film appearance (for example, smoothness, yellowing resistance, etc.) and design properties (for example, color reproducibility, high gloss, etc.), and having well-balanced coating film properties such as scratch resistance. The coating composition of the present invention can also form a coating film having superior scratch resistance for long-term use, and a coating film having superior chemical resistance.

Furthermore, since the coating composition of the present invention is a thermally curable coating composition, a coating film can be cured (formed) by a simple method.

For example, since the coating composition of the present invention is a thermally curable coating composition, it is possible to perform coating film formation, such as coating film curing, more easily, without using a special device used for curing of an ultraviolet curable resin composition. Furthermore, even though being a thermally curable coating composition, the coating composition of the present invention can form a coating film having good coating film appearance (for example, smoothness) and design properties, and having well-balanced coating film properties such as scratch resistance and coating film hardness.

Since the coating composition of the present invention comprises a branched polymer and the specific isocyanate compound of the present invention, it can form a coating film having physical properties equivalent to or higher than those of coating films formed from known ultraviolet curable coating compositions.

Although not limited to a particular theory, a crosslinking reaction occurs between a branched polymer and the specific isocyanate compound according to the present invention, and further the hybridization of inorganic and organic materials proceeds as a result of the condensation reaction in the specific silanol compound according to the present invention, so that the above-mentioned technical effects can be obtained.

Hereinafter, it is shown that even a thermally curable coating composition can form sufficient crosslinks.

For example, the molecular weight between crosslinks of the cured coating film in the coating composition of the present invention is, for example, 500 g/mol or less, for example, 300 g/mol or less, and in one embodiment, 200 g/mol or less, for example, 150 g/mol or less. The molecular weight between crosslinks of the cured coating film is, for example, 50 g/mol or more, and in one embodiment, 70 g/mol or more.

The coating composition of the present invention can have a molecular weight between crosslinks in such a range even though it is a thermally curable coating composition. Therefore, although the coating film obtained from the coating composition of the present invention is a coating film formed from a thermally curable coating composition, it can form a coating film being large in crosslinking density, having superior scratch resistance and hardness, and being capable of forming a dense coating film, and the coating film can be easily cured.

In the present description, the molecular weight between crosslinks is a calculated value determined by applying a measured value obtained by a dynamic viscoelasticity analyzer to a theoretical formula, and can be measured as follows.

The molecular weight between crosslinks of the cured coating film of the present invention is a theoretically calculated value determined by applying the value of the minimum modulus to the following rubber viscoelasticity theoretical formula, and can be calculated by the following formula.

Mc=3ρRT/Eₘᵢₙ (Formula 1)

Here,

Mc: molecular weight between crosslinks (g/mol),

ρ: density of coating film (g/m³),

R: gas constant (8.314 J/K/mol),

T: absolute temperature (K) at the absolute temperature when the storage modulus is Eₘᵢₙ,

Eₘᵢₙ: minimum value (Pa) of storage modulus at temperature T.

The coating film used for measuring the molecular weight between crosslinks was a cured coating film prepared by applying the coating composition to achieve a dry film thickness of 30 μm and baking it at 80° C. for 20 minutes to cure.

Hereinafter, the coating composition according to the present disclosure will be described in more detail.

(Branched Polymer)

The coating composition of the present invention comprises at least one branched polymer selected from a dendrimer and a hyperbranched polymer. When the branched polymer comprises both a dendrimer and a hyperbranched polymer, a combination of a dendrimer and a hyperbranched polymer both having the same terminal substituents is preferred.

The branched polymer is understood to be a polymer that is not or almost not crosslinked in the coating composition. This is neither structurally nor molecularly unified.

The “dendrimer” is a branched polymer having a structure in which a branched chain further has a plurality of branches to form a multibranched structure and the branched structure has a radially spread structure. For example, the dendrimer has a chemical structure in which branches are regularly repeated from the center of the polymer toward the outside, and may have a spherical three-dimensional structure.

The “hyperbranched polymer” has a structure in which the above-mentioned multibranched structure is spread not in a radial manner but in a prescribed one direction or two or more directions in a branched manner. For example, the hyperbranched polymer has a chemical structure similar to the dendrimer. However, the hyperbranched polymer seldom has a highly ordered branched structure or a highly controlled molecular weight which the dendrimer has, and its branches can be formed according to a probability distribution.

In addition, the hyperbranched polymer often has a broad molecular weight distribution. Since the branches can be formed according to the probability distribution, they have an overwhelmingly higher number of terminal functional groups than linear polymers. A hyperbranched polymer may be configured to have branched chains differing in length. The branched structure has a linear structure and may further have a functional side group.

Preferably, the branched polymer is a hyperbranched polymer. Compared to dendrimers, hyperbranched polymers can be appropriately controlled in terms of the number of terminal functional groups and the types of functional groups, and their steric hindrance can be easily controlled. For this reason, since terminal functional groups of hyperbranched polymers can be bonded to reactive groups of the isocyanate compound according to the present invention more effectively as compared to dendrimers, they can form a coating film having better coating film appearance (for example, smoothness) and design properties and also having well-balanced coating film properties such as better scratch resistance.

Examples of the hyperbranched polymer include, from the viewpoint of classification of a skeletal structure, hyperbranched polycarbonate, hyperbranched polyether, hyperbranched polyester, hyperbranched polyphenylene, hyperbranched polyamide, hyperbranched polyimide, hyperbranched polyamideimide, hyperbranched polysiloxane, and hyperbranched polycarbosilane. These hyperbranched polymers have a terminal group, and may have at least one type of functional group containing active hydrogen, such as a hydroxyl group as the terminal group.

In one embodiment, the branched polymer is a hyperbranched polyester.

According to this embodiment, the polyester polymer with a multibranched structure can be bonded to the isocyanate compound according to the present invention. Thereby, the coating film can have the flexibility of a polyester polymer with a multibranched structure (hyperbranched polyester) and, for example, an improvement in scratch resistance due to the self-condensation of alkylsilanol groups (in one embodiment, a silicate) in the isocyanate compound according to the present invention and good coating film hardness can be achieved at the same time.

In the present invention, the hyperbranched polyester may have an active hydrogen group, such as a hydroxyl group, as a terminal group. Such active hydrogen groups can react with isocyanate groups.

In one embodiment, the hydroxyl value of the branched polymer is 170 mg KOH/g or more and 300 mg KOH/g or less, for example, 210 mg KOH/g or more and 300 mg KOH/g or less, and preferably 220 mg KOH/g or more and 300 mg KOH/g or less.

When the hydroxyl value of the branched polymer is within such a range, a coating film having a high crosslinking density can be formed, and improved scratch resistance and good coating film hardness can be achieved.

In one embodiment, the hydroxyl value of the branched polymer is 250 mg KOH/g or more and 300 mg KOH/g or less. With the combination of the branched polymer of the present invention and the isocyanate compound, it is possible to form a coating film having a high crosslinking density even with a hydroxyl value in such a range, and improved scratch resistance and good coating film hardness can be achieved.

The hydroxyl value of the branched polymer can be measured by the neutralization titration method using potassium hydroxide described in JIS K0070.

In one embodiment, the acid value of the branched polymer is 5 mg KOH/g or more and 110 mg KOH/g or less, for example, 10 mg KOH/g or more and 90 mg KOH/g or less. When the acid value of the branched polymer is within such a range, intramolecular crosslinking, for example, gelation in the coating composition can be suppressed. When the acid value exceeds the above range, the compatibility with other resins may deteriorate and the water resistance may deteriorate, whereas when the acid value is below the above range, the crosslinking density may not increase sufficiently.

The weight-average molecular weight (Mw) of the branched polymer is, for example, 300 to 5000, for example, 400 to 4000, and in one embodiment, 500 to 3000.

The number-average molecular weight (Mn) of the branched polymer is, for example, 300 to 2500, for example, 400 to 2200, and in one embodiment, 500 to 2000.

The weight-average molecular weight (Mw) of the branched polymer is a value measured by gel permeation chromatography using HLC-8200 manufactured by Tosoh Corporation. The measurement conditions are as follows.

Column: TSgel Super Multipore HZ-M, three columns

Developing solvent: tetrahydrofuran

Column inlet oven: 40° C.

Flow rate: 0.35 ml

Detector: RI

Standard polystyrene: PS oligomer kit manufactured by Tosoh Corporation

The glass transition temperature (Tg) of the branched polymer is, for example, −20° C. to 70° C., and in one embodiment, −20 to 50° C.

The glass transition temperature as used herein is a value measured by the following process using a differential scanning calorimeter (DSC) (thermal analyzer SSC5200 (manufactured by Seiko Instruments Inc.)). Specifically, during a step of raising the temperature from 20° C. to 150° C. at a temperature raising rate of 10° C./min (step 1), a step of lowering the temperature from 150° C. to −50° C. at a temperature lowering rate of 10° C./min (step 2), and a step of raising the temperature from −50° C. to 150° C. at a temperature raising rate of 10° C./min (step 3), the value obtained from a chart at the time of raising the temperature in step 3 was taken as a glass transition temperature.

The coating composition of the present invention may further comprise a known resin and/or monomer as long as the properties of the branched polymer are not impaired. For example, the coating composition may comprise an acrylic resin, a melamine resin, a urethane resin, an olefin resin, or the like, or may comprise two or more species of these resins in combination.

The resin that can be added in addition to the branched polymer according to the present invention may, in one embodiment, have a hydroxyl value of 80 mg KOH/g or more and 300 mg KOH/g or less.

### [Isocyanate Compound]

The coating composition of the present invention comprises an isocyanate compound having an isocyanate group and an alkylsilanol group, and having the number of isocyanate functional group of 1 or more.

The isocyanate compound according to the present invention can increase the crosslinking density of a coating film, can suppress gelation of the branched polymer, and can form a desired coating film. Furthermore, since it is possible to favorably advance the crosslinking reaction with terminal functional groups present inside the branched polymer chain, the coating film formed from the coating composition of the present invention has good coating film appearance (for example, smoothness) and design properties, and can have well-balanced coating film properties such as scratch resistance.

Here, although it should not be construed as being limited to a particular theory, thanks to combining the branched polymer according to the present invention with the isocyanate compound according to the present invention, reactive functional groups of the branched polymer, for example, a large number of reactive functional groups present in branched parts react with isocyanate groups of the isocyanate compound, so that crosslinking advances. Furthermore, in the isocyanate compound according to the present invention bonded to the branched polymer, the condensation of the alkylsilanol groups present in the molecule proceeds.

As a result, the coating composition of the present invention is a thermally curable coating composition, but is presumed to be capable of forming a coating film having physical properties equivalent to or higher than those of known ultraviolet curable coating compositions.

In the isocyanate compound according to the present invention, the number of isocyanate functional group present in the compound is 1 or more, for example, 2 or more. For example, the number of isocyanate functional group present in the compound may be 10 or less, in one embodiment may be 5 or less, and more specifically may be 3 or less.

When the number of isocyanate functional group is within such a range, for example, the isocyanate compound according to the present invention and the active hydrogen groups (for example, hydroxyl groups) of the branched polymer have good reactivity, and the coating composition of the present invention can form a coating film having physical properties equivalent to or higher than those of known ultraviolet curable coating compositions even though being a thermally curable coating composition.

In one embodiment, the isocyanate compound according to the present invention has at least one alkylsilanol group selected from a monofunctional alkylsilanol group, a bifunctional alkylsilanol group, and a trifunctional alkylsilanol group.

Preferably, the isocyanate compound has at least one alkylsilanol group selected from a bifunctional alkylsilanol group and a trifunctional alkylsilanol group.

As a result, intramolecular condensation of silanol groups occurs in a coating film formed from the coating composition, so that a coating film having better coating film appearance (for example, smoothness), and also having well-balanced coating film properties such as scratch resistance can be formed.

The number of alkylsilanol group in the isocyanate compound can be appropriately chosen depending on the functional groups, etc. of the branched polymer.

The number of alkylsilanol group contained in the isocyanate compound is 1 or more per molecule. In one embodiment, the number of alkylsilanol groups contained in the isocyanate compound is 30 or less per molecule.

In one embodiment, the isocyanate compound according to the present invention has one or more alkylsilanol groups represented by the following formula (1),

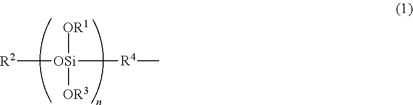

wherein R¹, R² and R³ are hydrocarbon groups having 1 to 20 carbon atoms and optionally having a substituent, provided that R¹, R² and R³ may be either the same as or different from each other,

R⁴ is a hydrocarbon group having 1 to 20 carbon atoms and optionally having a substituent, and

n is 1-10.

The R⁴ group in the formula (1) may be an organic chain containing an oxygen atom, a nitrogen atom or a sulfur atom existing between the Si atom and the NCO group. However, the oxygen atom, nitrogen atom or sulfur atom does not directly bond to the Si atom. The R⁴ group and the isocyanate group in the isocyanate compound according to the present invention may be adjacent to each other. The isocyanate compound may have another hydrocarbon group or the like between the R⁴ group and the isocyanate group.

In one embodiment, the isocyanate compound according to the present invention can undergo self-condensation within an alkylsilanol group thereof due to having one or more alkylsilanol groups represented by the formula (1). Thereby, the scratch resistance is further improved, and a coating film having better coating film hardness can be obtained.

In the coating composition of the present invention, the quantity of the isocyanate compound according to the present invention may be 0.8 equivalents or more and 1.5 equivalents or less per equivalent of the hydroxyl groups of the branched polymer in the coating composition. In one embodiment, the amount of the isocyanate compound according to the present invention is 1.0 equivalent or more and 1.5 equivalents or less per equivalent of hydroxyl groups of the branched polymer.

In the present description, when the coating composition of the present invention comprises a plurality of branched polymers, the quantity of the hydroxyl compound means the total of the quantity (equivalent) of the isocyanate compound relative to the quantity (equivalent) of the hydroxyl group calculated from the hydroxyl value of each of the plurality of branched polymers. The same applies to the following unless otherwise specified.

Thanks to containing the isocyanate compound in such an amount in the coating composition, it is possible to sufficiently react a branched polymer, especially, a multibranched polymer with a multibranched structure with the isocyanate compound according to the present invention, and a coating film having the flexibility of the branched polymer and also having superior scratch resistance due to the self-condensation of alkylsilanol groups of the isocyanate compound and a good coating film hardness can be obtained.

Even though being a thermally curable coating composition, the coating composition of the present invention can form a coating film having physical properties equivalent to or higher than those of known ultraviolet curable coating compositions.

(Catalyst)

The coating composition of the present invention may further comprise a catalyst. Thanks to containing the catalyst, for example, the reaction between reactive functional groups of the branched polymer according to the present invention and isocyanate groups of the isocyanate compound can be more selectively advanced, so that a coating film having higher surface hardness and scratch resistance can be obtained. In addition, the coating film can be formed at a lower temperature and/or the curing time of the coating composition can be further shortened. Furthermore, a coating film superior in heat-resistant coloration stability and thin film curability can be obtained.

In one embodiment, an acid catalyst may be used to accelerate the hydrolytic condensation of the alkylsilanol groups contained in the isocyanate compound. This is because the acid catalyst has an appropriate catalytic action, so that the condensation of the produced polyhydroxysiloxane proceeds to an appropriate degree. As the acid catalyst, any suitable one can be used as long as it is a protonic acid or a Lewis acid having a catalytic action on the hydrolysis reaction of an alkoxysilyl group. Specific examples of the protonic acid include inorganic acids such as hydrochloric acid, nitric acid, and sulfuric acid, and organic acids such as acetic acid, lactic acid, and p-toluenesulfonic acid, examples of the Lewis acid include alkoxides of metal, such as titanium, aluminum, and zirconium, and chelate compounds.

Besides the acid catalysts, a catalyst can be appropriately selected depending on the branched polymer and the isocyanate compound according to the present invention to be used. In one embodiment, the catalyst is a metal-free organic ion catalyst. By using a metal-free organic ion catalyst, the load on the environment can be further reduced. The metal-free organic ion catalyst is, for example, at least one species selected from the group consisting of amines, imidazoles, imidazolines, aromatic group-containing catalysts, and salts thereof.

The term “metal-free organic ion catalyst” as used herein means a catalyst that contains neither metal atoms nor metal ions in the chemical structure of the catalyst.

Examples of the imidazoles include 2-methylimidazole, 2-phenylimidazole, 2-ethylimidazole, 2-undecylimidazole, and 2-heptadecylimidazole.

Examples of the imidazolines include 2-ethylimidazoline, 2-phenylimidazoline, and 1-cyanoethyl-2-phenylimidazoline.

The catalyst may be an aliphatic polycarboxylic acid such as decanedicarboxylic acid, dodecanedicarboxylic acid, and sebacic acid, or an aromatic group-containing catalyst such as benzoic acid and a salt thereof.

The quantity of the catalyst may be 0.05 parts by mass or more and 3 parts by mass or less per 100 parts by mass of the resin solid content of the branched polymer in the coating composition of the present invention. In the present description, when the coating composition of the present invention comprises a plurality of branched polymers, “100 parts by mass of the resin solid content of the branched polymer” means “100 parts by mass in total of the resin solid content of the branched polymer”. In the following description, the same applies to the description “100 parts by mass of the resin solid content of the branched polymer” unless otherwise specified.

The coating composition of the present invention can be mixed with a coloring pigment such as a black pigment, and a coating film having a design such as piano black can be formed by one coating. On the other hand, if a coloring pigment is blended in a UV coating material, curing (coating film formation) is inhibited, so that a coating film having sufficient performance cannot be obtained.

As described above, the coating composition of the present invention can afford superior appearance (for example, smoothness) and scratch resistance though it is thermally curable. For example, as a method for adding the black pigment, a commercially available dispersion paste may be blended, or the coating composition of the present invention may be prepared by previously dispersing it in the branched polymer to be used in the present invention.

(Other Components)

The coating composition according to the present disclosure may, if necessary, contain, for example, additives such as a coloring pigment, an extender pigment, a modifier, a leveling agent, a dispersant, a defoaming agent, and a solvent as long as the physical properties of the branched polymer and the isocyanate compound contained in the coating composition of the present invention are not impaired. Furthermore, the coating composition preferably comprises a viscosity controlling agent in order to ensure coating workability. As the viscosity controlling agent, one that exhibits a thixotropic property can be commonly used. For example, as such a material, a conventionally known material can be used. In one embodiment, at least one of a known microgel and a non-aqueous dispersion type acrylic resin may be contained as a viscosity controlling agent (rheology control agent).

(Article to be Coated)

The coating composition of the present invention is suitably used for exterior materials of daily necessities, interior materials such as building materials, fittings, and flooring, automobile bodies and automobile parts (for example, exterior parts and interior parts), and exterior materials of home electric appliances, smart keys, smartphones, laptop computers, etc. Particularly preferred are electric products, electronic device parts, automobiles, and automobile parts.

For example, when it is used for automobile interior parts, it can be used for various plastic substrates and their molded products. It can be suitably used for plastic substrates based on polyolefin such as polypropylene, ABS resins, polycarbonate, etc. and their molded products, and it can be particularly suitably used for substrates based on polyolefin such as polypropylene, and molded products thereof.

If desired, an article having a known coating film, such as primer coating, formed thereon may be used.

Since the coating film formed from the coating composition of the present invention has good coating film appearance (for example, smoothness) and design properties, it can be applied, for example, to automobiles interior parts which are required to have a glossy feel such as metallic tone or piano black tone.

(Method for Forming Coating Film)

According to another embodiment of the present invention, there is provided a method for forming a coating film, which comprises applying the coating composition according to the present invention described above onto an article to be coated, and heating the coating composition to form a cured coating film, wherein the coating composition comprises a catalyst, and the heating is performed when the article to be coated is within a temperature of 70° C. or higher and 90° C. or lower.

According to this embodiment, the reaction between the branched polymer and the isocyanate compound is promoted, and the coating film can be formed at a lower temperature. Moreover, the curing time of the coating composition can be further shortened.

For example, the catalyst to be used may be a metal-free organic ion catalyst among the above-mentioned catalysts. This can further reduce the load on the environment.

The method for applying the coating composition of the present invention to the above-mentioned substrate is not particularly limited, and examples thereof include spray coating, a roll coater method, bell coating, disk coating, curtain coating, shower coating, spin coating, and brush coating. Usually, it may be applied such that the dry film thickness is within the range of 10 μm to 50 μm. Between coating and heating (baking and drying), it may be set by being left standing at normal temperature (room temperature) for an appropriate time.

The heating may be performed when the article to be coated is within a temperature of 70° C. or higher and 90° C. or lower, for example, 75° C. or higher and 90° C. or lower. When the temperature is lower than 70° C., curing may be insufficient. When the temperature exceeds 90° C., the load on the environment may increase, and the heat load on the substrate may occur. The time varies depending on the curing temperature (heating temperature), but when the temperature is 70° C. or higher and 90° C. or lower, the time is preferably 20 minutes or longer, for example, 25 minutes or longer and 60 minutes or shorter.

The coating composition of the present invention can afford superior coating film appearance (e.g., smoothness) and coating film properties, such as scratch resistance, without using a catalyst.

When the substrate that is an article to be coated is, for example, a substrate made of a metal material or a substrate made of fine ceramics, the heating may be performed when the article to be coated is within a temperature, for example, from 70° C. or higher to 150° C. or lower.

### EXAMPLES

The present invention will be described more specifically with reference to the following examples, but the present invention is not limited to the examples. In the examples, “parts” and “%” are on a mass basis unless otherwise indicated.

(Resin Component)

(P1) Basonol^{(registered trademark)} HPE 1170 B (BASF)

Hyperbranched polyester

(Hydroxyl value: 280 mg KOH/g, acid value: 85 mg KOH/g, weight-average molecular weight (Mw): 1800, glass transition temperature (Tg): 18° C.)

(P2) Acrylic resin

(Hydroxyl value: 170 mg KOH/g, acid value: 7 mg KOH/g)

(P3) JR-B754 (Mitsubishi Rayon Co., Ltd.) acrylic resin

(Hydroxyl value: 250 mg KOH/g, acid value: 3 mg KOH/g, glass transition temperature (Tg): 40° C.)

(Isocyanate Compound)

(I1) X-12-1159L (Shin-Etsu Chemical Co., Ltd.)

The number of isocyanate functional group: 2

(I2) KBE-9007 (Shin-Etsu Chemical Co., Ltd.)

The number of isocyanate functional group: 1

(I3) HDI isocyanurate

The number of isocyanate functional group: 3

(Catalyst)

Metal-free organic ion catalyst: Basionics^{(registered trademark)} KAT-1 (BASF)

Metal catalyst: tin catalyst (dibutyltin dilaurate)

(Additive)

Surface conditioning agent: BYK310 (ALTANA)

### Examples 1 to 4, Comparative Examples 1 to 3

Components were mixed according to a formulation shown in Table 1 and were diluted with butyl acetate to 40%. The metal-free organic ion catalyst Basionics^{(registered trademark)} KAT-1 was prepared in the form of a 10% solution in methyl ethyl ketone (MEK).

The obtained mixture was stirred with a disper, and thus the coating compositions of Examples 1 to 4 and Comparative Examples 1 to 3 were obtained.

In Table 1, the blending quantity of the isocyanate compound is shown by the equivalent ratio relative to the hydroxyl value of the branched polymer in the coating composition. The blending quantities of additives, catalysts, etc. indicate the blending quantities relative to 100 parts by mass of the resin solid content of the branched polymer in the coating composition.

(Formation of Coating Film)

Coating compositions described in Table 1 were applied to an article to be coated (a plate made of black ABS resin) by air spray coating such that the dry film thickness was 30 μm, followed by setting for 5 minutes, and then were baked to cure at 80° C. for 30 minutes. Thus, coating films were formed from the coating compositions of the present invention. Each of the test coating films obtained was evaluated as described below. The results obtained are shown in Table 1.

### Reference Example

A mixture of 60 parts by weight of a reactive acrylic polymer ART CURE RA-3602MI (manufactured by Negami Chemical Industrial Co., Ltd., nonvolatile content: 50%), 70 parts by weight of a mixture of pentaerythritol triacrylate/pentaerythritol tetraacrylate=55/45 (Osaka Organic Chemical Industry Ltd., Viscoat #300), and 2 parts by weight of Irgacure 184 (manufactured by BASF Japan Ltd.) was diluted with propylene glycol monomethyl ether (PGM) to adjust the nonvolatile content to 60%, and thus an active energy ray-curable composition was obtained. Then, in order to evaluate the isobutyl alcohol (IBA) dilution property, the composition was diluted to a nonvolatile content of 30% using isobutyl alcohol (IBA) in an amount double the composition. The liquid remained transparent.

The resulting active energy ray-curable composition was applied to an article to be coated (a plate made of black ABS resin) by air-spray coating such that the thickness of the coating film after drying was 10 μm, then was set for 5 minutes, and then was dried by heating at 80° C. for 2 minutes. Next, the coating film was irradiated with ultraviolet rays such that the integrated dose was 1000 mJ/cm² at an irradiation intensity of 150 mW/cm² using a high-pressure mercury lamp with an output of 120 mW/cm² as a light source, so that the coating film was cured. Thereby, a laminate with a hard coat layer was prepared.

The evaluation described below was performed in the same manner as in Example 1. The results obtained are shown in Table 1.

(Steel Wool Abrasion Resistance)

The steel wool abrasion resistance of the resulting coating film was evaluated using a plane abrasion tester manufactured by Daiei Kagaku Seiki Mfg. Co., Ltd. Before starting the test, the glossiness at an angle of 60° with respect to the coating film surface is measured with a micro-TRI-gloss (gloss meter manufactured by BYK). Since the friction area is 100×20 mm, the measurement points are 3 points, namely, the center of the friction test area of the test piece, and a 30 mm left point and a 30 mm right point each apart from the center, and the average of the measurements is taken as the glossiness of the pre-test area.

Next, a test piece is prepared. The test piece is an item prepared by uniformly press-bonding steel wool (made of Bonstar No. 0000 manufactured by Nippon Steel Wool Co., Ltd.) to one side of a double-sided tape cut into 20×20 mm, and this is bonded and fixed to a friction surface of a testing machine to form a friction block. The test piece is set in the testing machine, and a load of 21.6 N (2 Kg weight+200 g friction block) is applied thereto, and the test piece is reciprocated 50 times at a speed of 30 reciprocations per minute with a stroke length of 10 cm.

Within 30 minutes after the test, the glossiness at an angle of 60° with respect to the coating film surface is measured with a micro-TRI-gloss (gloss meter manufactured by BYK). The measurement points are 3 points, namely, the center of the friction test area, and a 30 mm left point and a 30 mm right point each apart from the center in the tested test piece, and the average of the measurements is taken as the glossiness of the tested area. The scratch resistance was evaluated by using the percentage of the quotient of the pre-test area to the tested area as the gloss retention by the abrasion test. The evaluation results are as follows.

⊙ (Scratch resistance is very good.): Gloss retention is 70% or more.

∘ (Scratch resistance is good.): Gloss retention is 60% or more and less than 70%.

Δ (Scratch resistance is slightly weak.): Gloss retention is 50% or more and less than 60%.

x (Scratch resistance is weak.): Gloss retention is less than 50%.

(Smoothness)

In the evaluation of smoothness, the values of Wa and Wd obtained by using a micro-wave-scan (a coating surface texture analyzer manufactured by BYK) were evaluated according to the following criteria.

(Evaluation of Smoothness)

⊙ (Very good): Both the values of Wa and Wd are 2 or less.

∘ (Good): At least one of the values of Wa and Wd is greater than 2 and less than 5.

Δ (Slightly poor): At least one of the values of Wa and Wd is greater than 5 and less than 10.

x (Poor): At least one of the values of Wa and Wd exceeds 10.

TABLE 1

| | | Example | Example | Example | Example | Comparative | Comparative | Comparative | Reference |
|---|---|---|---|---|---|---|---|---|---|
| Coating composition | | 1 | 2 | 3 | 4 | Example 1 | Example 2 | Example 3 | Example |
| Main | HPE1170B (equivalents) | 100 | 50 | 100 | 100 | 100 | | | Active |
| ingredients | Acryl (equivalents) | | 50 | | | | 100 | | energy ray- |
| | JR-B754 (equivalents) | | | | | | | 100 | curable |
| Isocyanate compound (I1) *1 | | 95 | 80 | 95 | | | 60 | 85 | composition |
| Isocyanate compound (12) *1 | | | | | 130 | | | | |
| Isocyanate compound (I3) *1 | | | | | | 105 | | | |
| Additive | BYK310 *2 | 0.1 | 0.1 | 0.1 | 0.1 | 0.1 | 0.1 | 0.1 | |
| Catalyst | KAT-1 *2 | 1 | 1 | | 1 | 1 | 1 | 1 | |
| | Tin *2 | | | 0.1 | | | | | |

| | | | | | | | | |
|---|---|---|---|---|---|---|---|---|
| Steel wool abrasion resistance | ⊙ | ⊙ | ◯ | ⊙ | x | x | x | ⊙ |
| 50 times GR | | | | | | | | |
| 60° | | | | | | | | |
| Smoothness | ⊙ | ⊙ | ⊙ | ⊙ | x | ⊙ | x | ⊙ |

*1 The blending quantity of the isocyanate compound is an equivalent ratio relative to the hydroxyl value of the branched polymer in the coating composition.
*2 The blending quantities of the additive and the catalyst are blending quantities per 100 parts by mass of the resin solid content of the branched polymer in the coating composition.

As described above, the present disclosure can provide a coating composition that forms a coating film having good coating film appearance (smoothness) and design properties, and having well-balanced coating film properties such as scratch resistance. The coating composition of the present invention can also form a coating film having superior scratch resistance for long-term use, and a coating film having superior chemical resistance.

On the other hand, in Comparative Example 1, the scratch resistance was poor and the coating film appearance (for example, smoothness) was insufficient. In Comparative Example 2, the scratch resistance was poor, and in Comparative Example 3, the scratch resistance was poor and the coating film appearance (for example, smoothness) was also insufficient.

In addition, in Reference Example, the scratch resistance was good, and the coating film appearance (for example, smoothness) was sufficient.

### INDUSTRIAL APPLICABILITY

According to the present invention, it is possible to provide a coating composition capable of forming a coating film having good coating film appearance (for example, smoothness) and design properties, and having well-balanced coating film properties such as scratch resistance. Furthermore, the present invention can provide a method for forming a multilayer coating film, which comprises forming a coating film using the coating composition of the present invention.

1. A coating composition comprising:
at least one branched polymer selected from a dendrimer and a hyperbranched polymer; and
an isocyanate compound having an isocyanate group and an alkylsilanol group, and having the number of isocyanate functional group of 1 or more.

2. The coating composition according to claim 1, wherein the branched polymer is a hyperbranched polyester.

3. The coating composition according to claim 1, wherein a hydroxyl value of the branched polymer is 170 mg KOH/g or more and 300 mg KOH/g or less.

4. The coating composition according to claim 1,
wherein the isocyanate compound has at least one alkylsilanol group represented by formula (1), 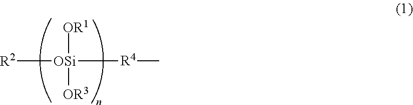
wherein R¹, R² and R³ are hydrocarbon groups having 1 to 20 carbon atoms and optionally having a substituent, provided that R¹, R² and R³ may be either the same as or different from each other,
R⁴ is a hydrocarbon group having 1 to 20 carbon atoms and optionally having a substituent, and
n is 1-10.

5. The coating composition according to claim 1, further comprising a metal-free organic ion catalyst.

6. A method for forming a coating film, comprising:
applying the coating composition according to claim 1 to an article to be coated; and
heating the coating composition to form a cured coating film,
wherein the coating composition comprises a catalyst, and
the heating is performed when the article to be coated is within a temperature of 70° C. or higher and 90° C. or lower.

7. The method according to claim 6, wherein the catalyst is a metal-free organic ion catalyst.

8. The coating composition according to claim 2, wherein a hydroxyl value of the branched polymer is 170 mg KOH/g or more and 300 mg KOH/g or less.

9. The coating composition according to claim 2,
wherein the isocyanate compound has at least one alkylsilanol group represented by formula (1), 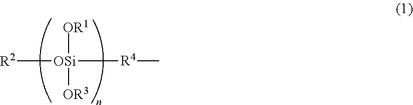
wherein R¹, R² and R³ are hydrocarbon groups having 1 to 20 carbon atoms and optionally having a substituent, provided that R¹, R² and R³ may be either the same as or different from each other,
R⁴ is a hydrocarbon group having 1 to 20 carbon atoms and optionally having a substituent, and
n is 1-10.

10. The coating composition according to claim 3,
wherein the isocyanate compound has at least one alkylsilanol group represented by formula (1), 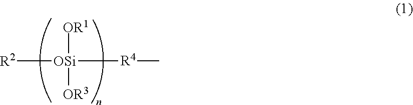
wherein R¹, R² and R³ are hydrocarbon groups having 1 to 20 carbon atoms and optionally having a substituent, provided that R¹, R² and R³ may be either the same as or different from each other,
R⁴ is a hydrocarbon group having 1 to 20 carbon atoms and optionally having a substituent, and
n is 1-10.

11. The coating composition according to claim 2, further comprising a metal-free organic ion catalyst.

12. The coating composition according to claim 3, further comprising a metal-free organic ion catalyst.

13. The coating composition according to claim 4, further comprising a metal-free organic ion catalyst.

14. A method for forming a coating film, comprising:
applying the coating composition according to claim 2 to an article to be coated; and
heating the coating composition to form a cured coating film,
wherein the coating composition comprises a catalyst, and
the heating is performed when the article to be coated is within a temperature of 70° C. or higher and 90° C. or lower.

15. A method for forming a coating film, comprising:
applying the coating composition according to claim 3 to an article to be coated; and
heating the coating composition to form a cured coating film,
wherein the coating composition comprises a catalyst, and
the heating is performed when the article to be coated is within a temperature of 70° C. or higher and 90° C. or lower.

16. A method for forming a coating film, comprising:
applying the coating composition according to claim 4 to an article to be coated; and
heating the coating composition to form a cured coating film,
wherein the coating composition comprises a catalyst, and
the heating is performed when the article to be coated is within a temperature of 70° C. or higher and 90° C. or lower.
